(19) United States
(12) Patent Application Publication
(10) Pub. No.: US 2026/0159369 A1
(43) Pub. Date: Jun. 11, 2026

(54) MULTIFUNCTIONAL BOTTLE OPENER

(71) Applicant: Shenzhen Yingxiang Technology Co., Ltd., Shenzhen (CN)

(72) Inventor: SHIRU FANG, Loudi (CN)

(21) Appl. No.: 19/272,925

(22) Filed: Jul. 17, 2025

(30) Foreign Application Priority Data
Dec. 5, 2024 (CN) 202422994829.X

(51) Int. Cl. B67B 7/44; B67B 7/16; B67B 7/18; B67B 7/40

(52) U.S. Cl. CPC B67B 7/44; B67B 7/16; B67B 7/18; B67B 7/40

(57) ABSTRACT

A multifunctional bottle opener is provided, which includes a mango-shaped flat plate. An inner side of the mango-shaped flat plate is provided with a recess configured to accommodate a can lid. The mango-shaped flat plate is provided with an installation groove, and the installation groove is communicated to the recess. The installation groove is sequentially provided with a first serrated plate, a clamp plate, and a second serrated plate, and serrations of the first serrated plate and the second serrated plate are provided in the recess. The first serrated plate, the clamp plate, and the second serrated plate are all provided with a plurality of installation holes. A threaded hole is provided directly opposite the installation hole in the installation groove, and a screw is provided in the installation hole. This multifunctional bottle opener greatly enhances the convenience and versatility of use, thereby meeting needs of different scenarios.

### CROSS-REFERENCE TO RELATED APPLICATIONS

This application claims priority to Chinese Patent Application No. 202422994829.X, filed on December 05, 2024, which is hereby incorporated by reference in its entirety.

### TECHNICAL FIELD

The present disclosure relates to the field of multifunctional bottle opener technologies, and in particular, to a multifunctional bottle opener.

### BACKGROUND

At present, the multifunctional bottle openers on the market generally have the problem of limited applicability. Some bottle opener designs are limited to opening spiral can lids, and others can only handle specific shaped lids such as beer bottle caps, and some are only suitable for opening cans, which lack a versatile bottle opener that can be widely compatible with different types of lids.

Therefore, a multifunctional bottle opener to address the aforementioned issues is provided.

### SUMMARY

To solve the above technical problems, the present disclosure provides a multifunctional bottle opener.

The present disclosure provides a multifunctional bottle opener, including a mango-shaped flat plate, where a recess configured to accommodate a can lid is provided on an inner side of the mango-shaped flat plate, an installation groove is provided on the mango-shaped flat plate, and the installation groove is communicated to the recess; a first serrated plate, a clamp plate, and a second serrated plate are sequentially provided in the installation groove from inside to outside, and serrations of the first serrated plate and the second serrated plate are provided in the recess; the first serrated plate, the clamp plate, and the second serrated plate are all provided with a plurality of installation holes; a threaded hole is provided in the installation groove facing the installation holes; a screw is provided in the installation holes, and the screw is connected to the threaded hole through threads; the first serrated plate, the clamp plate, and the second serrated plate are fixedly connected to the mango-shaped flat plate through the screw, one end of the mango-shaped flat plate is provided with an opening, the other end of the mango-shaped flat plate is provided with a clamp slot, an interior of the clamp slot is provided with a support plate and a rocker plate.

In some embodiments of the present disclosure, a side wall of the mango-shaped flat plate is integrated with a hook plate.

In some embodiments of the present disclosure, an interior of the mango-shaped flat plate is provided with a beer bottle cap opening.

In some embodiments of the present disclosure, a stepped hole is provided on the mango-shaped flat plate, and the stepped hole is communicated to the recess; magnets are provided in the stepped hole, one of the magnets is close to the beer bottle cap opening.

In some embodiments of the present disclosure, one end face of the magnets is flush with a concave surface of the recess, the other end face of the magnets is flush with an outer surface of the mango-shaped flat plate.

In some embodiments of the present disclosure, a decorative plate is adhered and fixed in the recess.

In some embodiments of the present disclosure, an outer side of the mango-shaped flat plate is provided with a rotation indicator arrow.

In some embodiments of the present disclosure, a side wall of the mango-shaped flat plate is provided with anti-slip patterns.

In some embodiments of the present disclosure, a rounded corner is provided at an edge of the mango-shaped flat plate.

In some embodiments of the present disclosure, the mango-shaped flat plate is a metal material component.

Compared with related technologies, the present disclosure provides the following beneficial effects.

Multifunctionality: in addition to the basic can opening function, it also integrates various additional functions such as lifting a pull tab of a can, lifting a bottle cap (including beer bottle caps and various can caps), and hooking the pull tab, greatly improving the convenience and versatility of use, and meeting the needs of different scenarios.

Stable structure: through installation groove and multi-layer serrated plate structure, combined with screw fixation, the multifunctional bottle opener ensures stable insertion and rotation of the can lid during use, thereby improving the success rate and safety of opening.

### BRIEF DESCRIPTION OF DRAWINGS

FIG. 1 is a first schematic diagram of an outer side of an overall structure of the present disclosure.

FIG. 2 is a schematic diagram of an inner side of the overall structure of the present disclosure.

FIG. 3 is a second schematic diagram of the outer side of the overall structure of the present disclosure.

FIG. 4 is a schematic structural diagram of a second serrated plate of the present disclosure.

FIG. 5 is a schematic diagram of opening a can of the present disclosure.

FIG. 6 is a schematic diagram of a pull ring of a flip can of the present disclosure.

FIG. 7 is a schematic diagram of opening a bottle cap in the present disclosure.

FIG. 8 is a schematic diagram of a rocker hook pull ring of the present disclosure.

Numeral reference: 1- mango-shaped flat plate; 2- recess; 3- installation groove; 4- first serrated plate; 5- clamp plate; 6- second serrated plate; 7- installation hole; 8- threaded hole; 9- screw; 10- opening; 11- clamp slot; 12- support plate; 13- hook plate; 14- beer bottle cap opening; 15- stepped hole; 16- magnet; 17- decorative plate; 18- rotation indicator arrow; 19- anti-slip pattern; 20- rounded corner; 21- rocker plate.

### DESCRIPTION OF EMBODIMENTS

Further explanation of the present disclosure will be provided in combination with the accompanying drawings and embodiments.

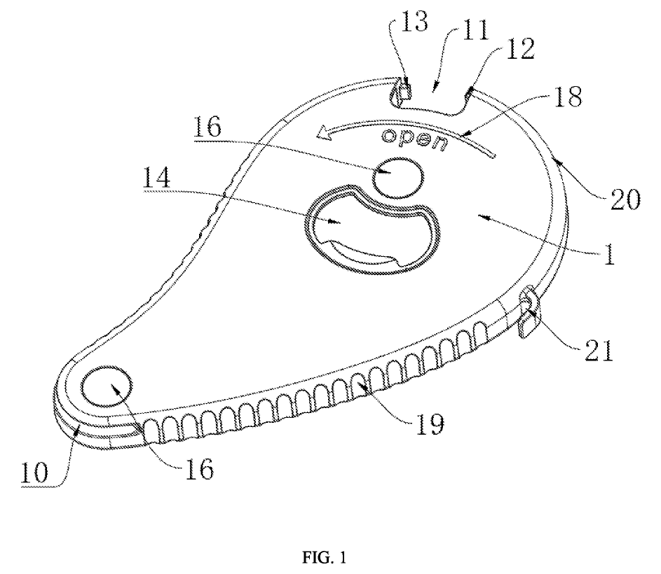

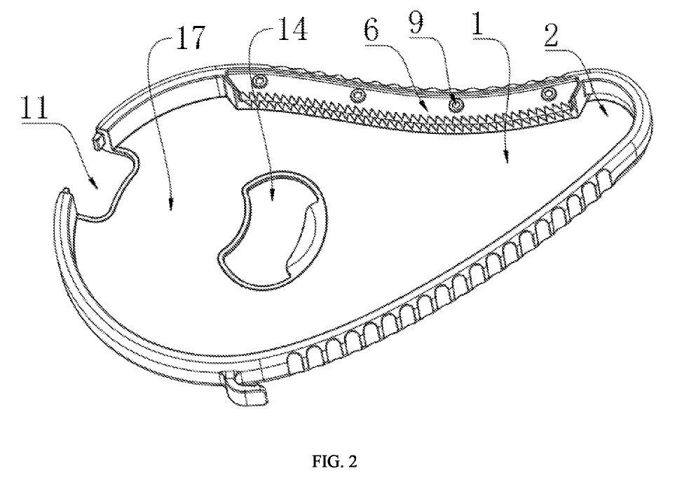

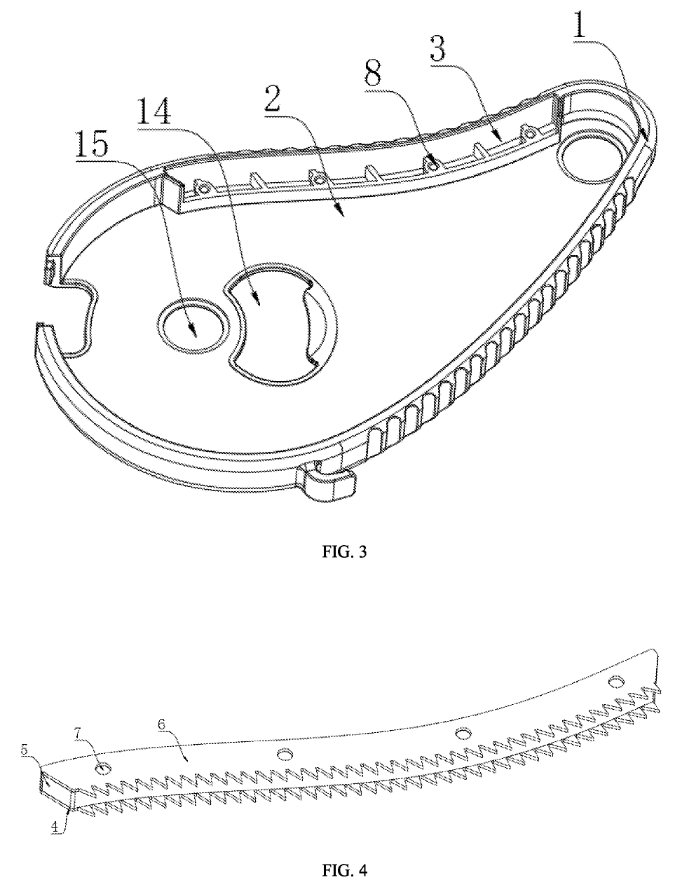

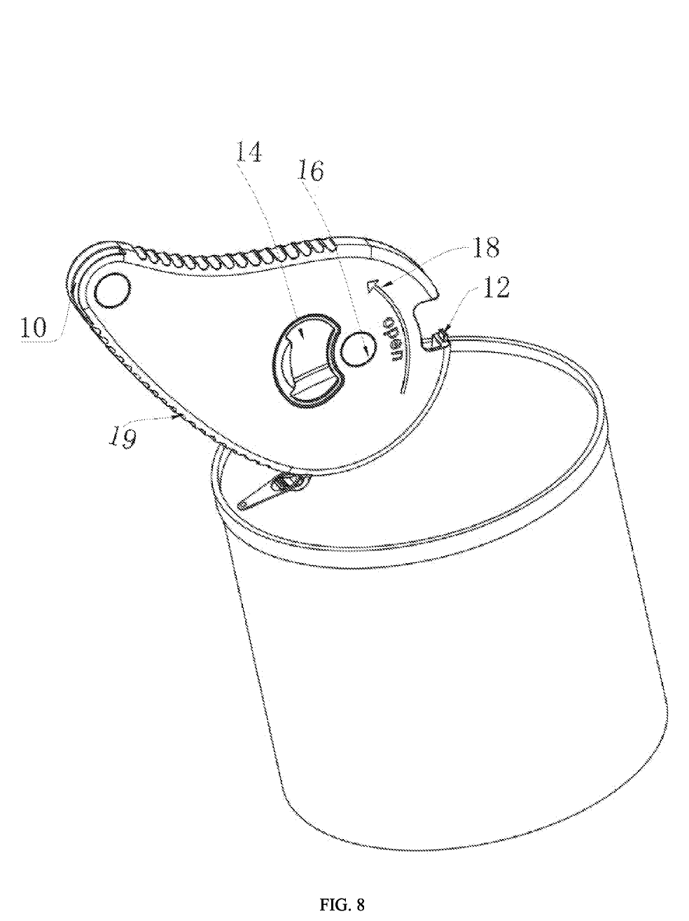

Please refer to FIGS. 1 to 8 for a multifunctional bottle opener, which includes a mango-shaped flat plate 1. An inner side of this plate is provided with a recess 2, to securely hold and fix a lid of a can, ensuring stability during an opening process. On the mango-shaped flat plate 1, an installation groove 3 is further connected to the recess 2, thereby providing an installation space for internal components.

In the installation groove 3, a first serrated plate 4, a clamp plate 5, and a second serrated plate 6 are arranged from inside to outside. Serrated parts of these two serrated plates are extended into the recess 2, becoming key parts for piercing into the can lid. In order to ensure that these components can be firmly fixed on the mango-shaped flat plate 1, multiple installation holes 7 are evenly distributed on the first serrated plate 4, the clamp plate 5, and the second serrated plate 6. Correspondingly, a threaded hole 8 is provided in the installation groove 3 at a position opposite to these installation holes 7. By screwing a screw 9 into these installation holes 7 and tightly fitting them with the threaded holes 8, the first serrated plate 4, the clamp plate 5, and the second serrated plate 6 are firmly fixed to the mango-shaped flat plate 1, thereby forming a stable whole.

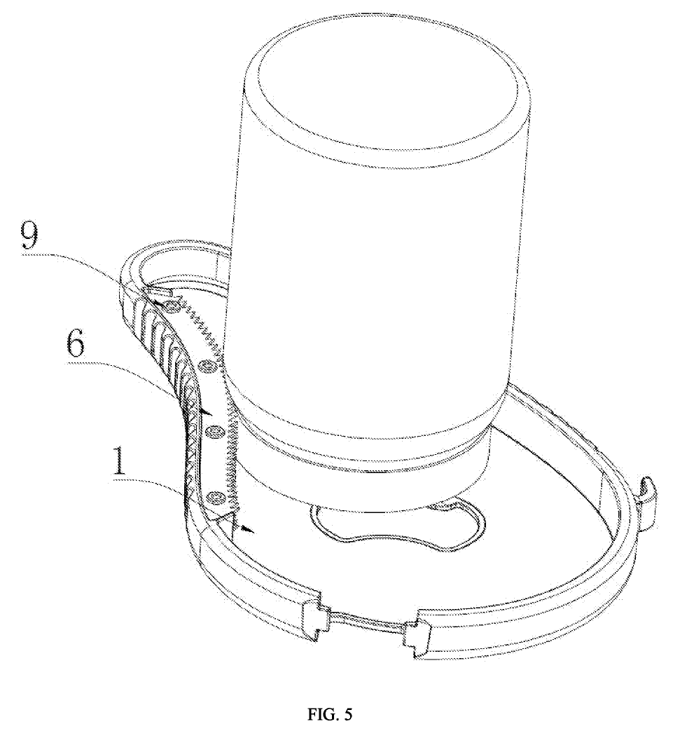

When opening the can, the lid of the can is tightly contact with the recess 2, the mango-shaped flat plate 1 is pushed, so that teeth of the first serrated plate 4 and the second serrated plate 6 are pierced into the lid of the can. A can body is held with one hand and the mango-shaped flat plate 1 is rotated with the other hand to remove the lid. As shown in FIG. 5.

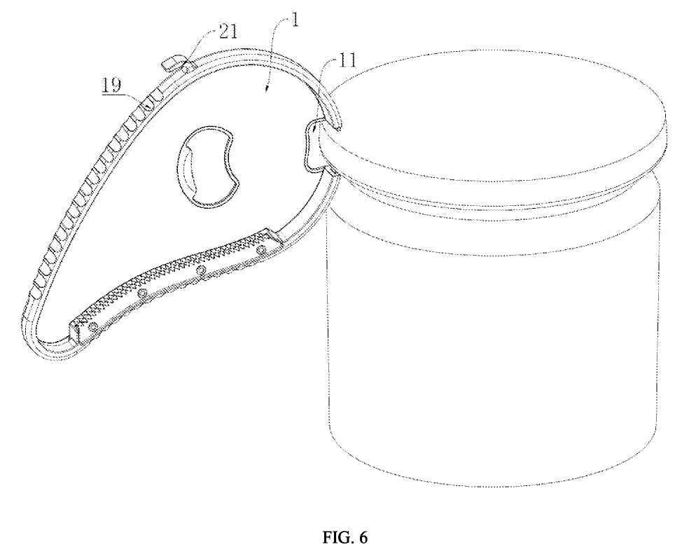

In addition to the basic can opening function, this multifunctional bottle opener integrates multiple additional functions. One end of the mango-shaped flat plate 1 is provided with an opening 10, and a thin raised part is formed at a position facing the opening. This thin raised part can easily lift a pull tab of a soda can, thereby providing great convenience for a user who enjoys drinking beverages, as shown in FIG. 6.

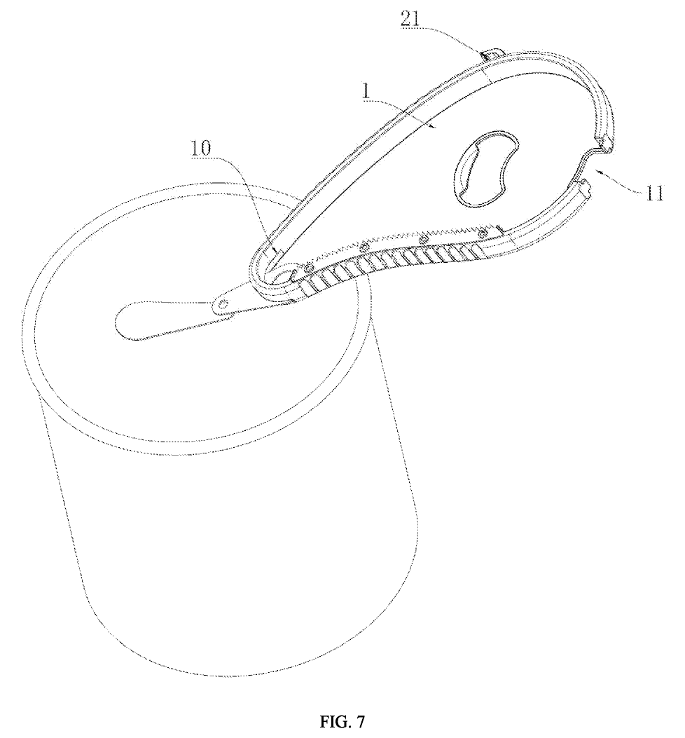

On the other end of the mango-shaped flat plate 1, there is a clamp slot 11. The clamp slot 11 is provided with a support plate 12 and a rocker plate 21. The clamp slot 11 is simply fastened onto an edge of the lid, and the support plate 12 will come into close contact with a top of the lid, serving as a fulcrum for a lever. And the rocker plate 21 will be extended into a gap at a connection between the bottle body and the lid. With the principle of leverage, the user can easily remove bottle caps (such as beer caps or can caps) by gently prying them, regardless of the size of the cap, as shown in FIG. 7.

A side wall of the mango-shaped flat plate 1 is integrated with a hook plate 13, which can be used to hook a pull ring.

An interior of the mango-shaped flat plate 1 is provided with a beer bottle cap opening 14, which is convenient for opening the beer bottle cap.

The mango-shaped flat plate 1 is provided with a stepped hole 15, and the stepped hole 15 is communicated to the recess 2. Magnets 16 are provided in the stepped hole 15, and one of the magnets 16 is close to the beer bottle cap opening 14 to attract the cap and prevent it from falling off.

The magnets 16 can hold the beer bottle cap when opening it and prevent it from falling off. Another use of the magnets 16 is for storage, and it can be attached to refrigerators or devices with iron.

One end face of the magnets 16 is flush with a concave surface of the recess 2, and the other end face of the magnets 16 is flush with an outer surface of the mango-shaped flat plate 1. Thus, an overall appearance is more beautiful.

Besides that, a decorative plate 17 is bonded and fixed inside the recess 2, further enhancing the overall beauty of the multifunctional bottle opener. An outer side of the mango-shaped flat plate 1 is further provided with a rotation indicator arrow 18, which facilitates the user to quickly find a correct rotation direction during use. At the same time, anti-slip patterns 19 on a side wall provides the user with a better grip experience, rendering it easy to apply force even in wet or greasy environments. A rounded corner 20 provided at an edge makes the entire multifunctional bottle opener more rounded and smoother, with a better hand feel.

The mango-shaped flat plate 1 is a metal component with high strength and good durability.

The above description is only embodiments of the present disclosure and does not limit the scope of the present disclosure. Any equivalent structure or equivalent process transformation made using the content of the present disclosure specification and drawings, or directly or indirectly applied in other related technical fields, are also included in the protection scope of the present disclosure.

What is claimed is:

1. A multifunctional bottle opener, comprising a mango-shaped flat plate,
wherein a recess configured to accommodate a can lid is provided on an inner side of the mango-shaped flat plate,
an installation groove is provided on the mango-shaped flat plate, and the installation groove is communicated to the recess;
a first serrated plate, a clamp plate, and a second serrated plate are sequentially provided in the installation groove from inside to outside, and serrations of the first serrated plate and the second serrated plate are provided in the recess;
one end of the mango-shaped flat plate is provided with an opening, the other end of the mango-shaped flat plate is provided with a clamp slot,
an interior of the clamp slot is provided with a support plate and a rocker plate.

2. The multifunctional bottle opener according to claim 1, wherein the first serrated plate, the clamp plate, and the second serrated plate are all provided with a plurality of installation holes;
a threaded hole is provided in the installation groove facing the installation holes;
a screw is provided in the installation holes, and the screw is connected to the threaded hole through threads;
the first serrated plate, the clamp plate, and the second serrated plate are fixedly connected to the mango-shaped flat plate through the screw,
a side wall of the mango-shaped flat plate is integrated with a hook plate.

3. The multifunctional bottle opener according to claim 1, wherein an interior of the mango-shaped flat plate is provided with a beer bottle cap opening.

4. The multifunctional bottle opener according to claim 1, wherein a stepped hole is provided on the mango-shaped flat plate, and the stepped hole is communicated to the recess;
magnets are provided in the stepped hole,
one of the magnets is close to the beer bottle cap opening.

5. The multifunctional bottle opener according to claim 4, wherein one end face of the magnets is flush with a concave surface of the recess,
the other end face of the magnets is flush with an outer surface of the mango-shaped flat plate.

6. The multifunctional bottle opener according to claim 1, wherein a decorative plate is adhered and fixed in the recess.

7. The multifunctional bottle opener according to claim 1, wherein an outer side of the mango-shaped flat plate is provided with a rotation indicator arrow.

8. The multifunctional bottle opener according to claim 3, wherein a side wall of the mango-shaped flat plate is provided with anti-slip patterns.

9. The multifunctional bottle opener according to claim 1, wherein a rounded corner is provided at an edge of the mango-shaped flat plate.

10. The multifunctional bottle opener according to claim 1, wherein the mango-shaped flat plate is a metal material component.
